(19) United States
(12) Patent Application Publication
(10) Pub. No.: US 2023/0401775 A1
(43) Pub. Date: Dec. 14, 2023

(54) FACE MODEL BUILDING METHOD AND FACE MODEL BUILDING SYSTEM

(71) Applicant: ASUSTEK COMPUTER INC., TAIPEI (TW)

(72) Inventors: Yi-Hsuan TSAI, TAIPEI (TW); Kuan-Ling CHEN, TAIPEI (TW); Jo-Hsuan HUANG, TAIPEI (TW); Jun-Ting CHEN, TAIPEI (TW); Shih-Hua MA, TAIPEI (TW); Chieh-Han CHUANG, TAIPEI (TW)

(21) Appl. No.: 18/084,889

(22) Filed: Dec. 20, 2022

(30) Foreign Application Priority Data
Jun. 9, 2022 (CN) 202210650780.9

(51) Int. Cl. G06T 13/40; G06T 17/00; G06T 13/80

(52) U.S. Cl. CPC G06T 13/40; G06T 17/00; G06T 13/80

(57) ABSTRACT

A face model building method is provided. The face model building method includes: obtaining a plurality of facial feature animation objects and a plurality of object parameters respectively corresponding to the facial feature animation objects, where the facial feature animation objects include a plurality of two-dimensional facial feature animation objects and at least one three-dimensional facial feature animation object; and integrating the facial feature animation objects according to the object parameters to generate a three-dimensional face model. A face model building system is further provided.

### CROSS-REFERENCE TO RELATED APPLICATION

This application claims the priority benefit of Chinese application ser. No. 202210650780.9, filed on Jun. 9, 2022. The entirety of the above-mentioned patent application is hereby incorporated by reference herein and made a part of the specification.

### BACKGROUND OF THE INVENTION

### Field of the Invention

The disclosure relates to the field of face model building technologies, and in particular, to a face model building method and a face model building system.

### Description of the Related Art

Face presentation is a very important issue in the production of robots. For enterprises, different robot role requirements are needed on different occasions, such as: a friendly role in a bank, a professional appearance in a hospital, and the like, all of which need to be matched with different face designs.

In order to meet the requirements of diverse face designs, a conventional method needs to reproduce face models and expressions according to each different role, which is complicated and costly.

### BRIEF SUMMARY OF THE INVENTION

The disclosure provides a face model building method, applicable to a face model building system. The face model building method includes: obtaining a plurality of facial feature animation objects and a plurality of object parameters respectively corresponding to the facial feature animation objects, where the facial feature animation objects include a plurality of two-dimensional facial feature animation objects and at least one three-dimensional facial feature animation object; and integrating the facial feature animation objects according to the object parameters to generate a three-dimensional face model.

The disclosure further provides a face model building system, where the face model building system includes a model building platform and a display platform. The model building platform includes a plurality of facial feature animation objects and a plurality of object parameters respectively corresponding to the facial feature animation objects. The model building platform integrates the facial feature animation objects according to the object parameters to generate a three-dimensional face model, where the facial feature animation objects include a plurality of two-dimensional facial feature animation objects and at least one three-dimensional facial feature animation object. The display platform includes a display. The display platform receives the three-dimensional face model from the model building platform and presents the three-dimensional face model on the display.

Through the face model building system and the method thereof provided by the disclosure, the model building platform is configured to integrate the facial feature animation objects according to the object parameters to generate the three-dimensional face model for use. The facial feature animation objects include a plurality of two-dimensional facial feature animation objects and at least one three-dimensional facial feature animation object, so as to decrease the time and costs for model building, and improve the delicacy and vividness of the three-dimensional face model.

### BRIEF DESCRIPTION OF THE DRAWINGS

FIG. 1 is a schematic block diagram of a face model building system according to an embodiment of the disclosure;

FIG. 2A and FIG. 2B are respectively a schematic front view and a schematic side view of an embodiment of a three-dimensional face model built by the face model building system in FIG. 1;

FIG. 3 is a schematic diagram of an embodiment of a human-machine interface of the face model building system in FIG. 1;

FIG. 4 is a schematic block diagram of a face model building system according to another embodiment of the disclosure;

FIG. 5 is a flowchart of a face model building method according to an embodiment of the disclosure; and

FIG. 6 is a flowchart of a face model building method according to another embodiment of the disclosure.

### DETAILED DESCRIPTION OF THE EMBODIMENTS

More detailed descriptions of the specific embodiments of the disclosure are provided below with reference to the accompanying drawings. The features and advantages of the disclosure are described more clearly according to the following description and claims. It is to be noted that all of the drawings use very simplified forms and imprecise proportions, only being used for assisting in conveniently and clearly explaining the objective of the embodiments of the disclosure.

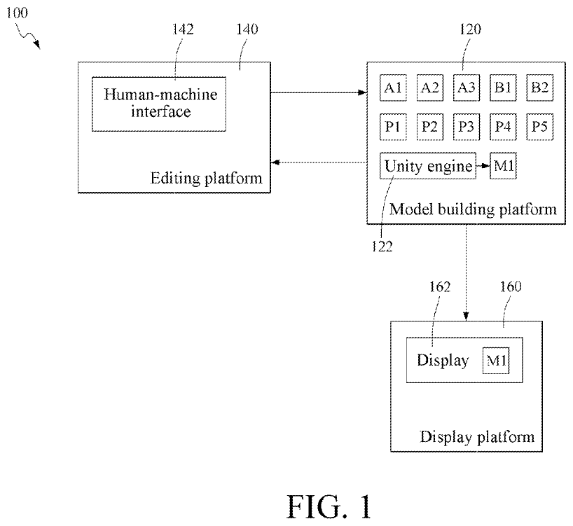

FIG. 1 is a schematic block diagram of a face model building system 100 according to an embodiment of the disclosure. As shown in the figure, the face model building system 100 includes a model building platform 120, an editing platform 140, and a display platform 160.

The model building platform 120 includes a plurality of facial feature animation objects A1, A2, A3, B1, and B2 and a plurality of object parameters P1, P2, P3, P4, and P5 respectively corresponding to the facial feature animation objects A1, A2, A3, B1, and B2. The model building platform 120 integrates the facial feature animation objects A1, A2, A3, B1, and B2 according to the object parameters P1, P2, P3, P4, and P5 to generate a three-dimensional face model M1. The facial feature animation objects A1, A2, A3, B1, and B2 include a plurality of two-dimensional facial feature animation objects and at least one three-dimensional facial feature animation object. This embodiment shows three two-dimensional facial feature animation objects A1, A2, and A3 and two three-dimensional facial feature animation objects B1 and B2 as an example.

In an embodiment, the model building platform 120 includes a Unity engine 122, and the Unity engine 122 uses the object parameters P1, P2, P3, P4, and P5 to control a property of the three-dimensional face model to present the three-dimensional face model M1. In an embodiment, the model building platform 120 is installed on a server.

In an embodiment, each of the object parameters P1, P2, P3, P4, and P5 respectively includes a position parameter, a size parameter, and a color parameter. The size parameter and the position parameter are both two-dimensional parameters.

The editing platform 140 communicates with the model building platform 120 through a network, and includes a human-machine interface 142 for a user to input an instruction to edit the facial feature animation objects A1, A2, A3, B1, and B2. In an embodiment, the editing platform 140 is installed on an electronic device including the human-machine interface 142, such as a portable electronic device. In an embodiment, the human-machine interface 142 is installed on a network browser.

The display platform 160 includes a display 162. The display platform 160 communicates with the model building platform 120 through the network to receive the three-dimensional face model M1 and present the three-dimensional face model M1 on the display 162. In an embodiment, the display platform 160 is a robot or another electronic device which includes the display 162 and is interactive. Further, in an embodiment, the editing platform 140 and the display platform 160 are integrated.

Compared with the editing platform 140 which shows a preview of the editing of the user on the three-dimensional face model M1l, the display platform 160 is mainly used for presenting the three-dimensional face model M1 after editing. Since the editing platform 140 has a display function as well, in an embodiment, the display platform 160 is omitted in the face model building system 100. In other embodiments, the editing platform 140 and the display platform 160 are integrated.

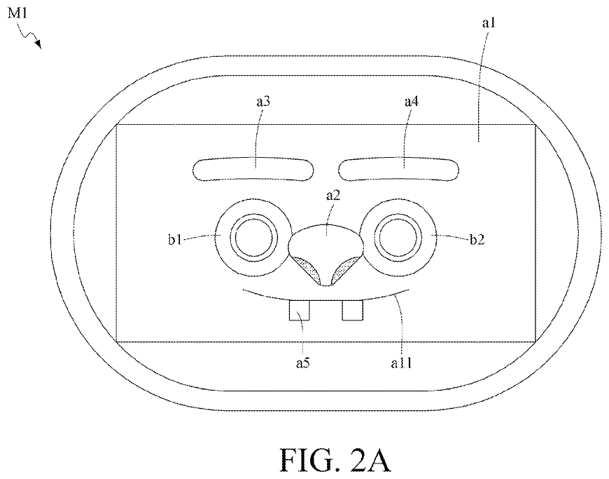

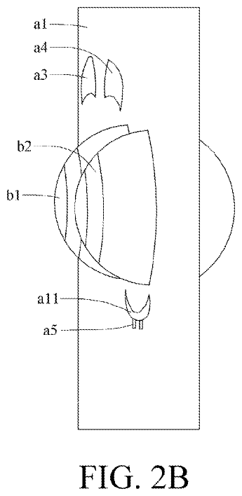

Referring to FIG. 2A and FIG. 2B, FIG. 2A and FIG. 2B are respectively a schematic front view and a schematic side view of an embodiment of a three-dimensional face model M1 built by the face model building system 100 in FIG. 1.

In an embodiment, the three-dimensional face model M1 includes a face base a1, a nose part a2, two eye parts b1 and b2, and two eyebrow parts a3 and a4.

In the facial feature animation objects, the two eye parts b1 and b2 are three-dimensional facial feature animation objects. The face base a1, the nose part a2, and the eyebrow parts a3 and a4 are all two-dimensional facial feature animation objects.

In an embodiment, the eye parts b1 and b2 include a white part and an eyeball part, where a size of the white part is fixed. That is to say, the object parameters corresponding to the eye parts b1 and b2 do not include adjustable parameters which relate to the size of the white part. In an embodiment, the face base al includes a mouth part all and a periphery of the face base is fixed. In an embodiment, the facial feature animation objects further include a tooth part a5, and the tooth part a5 is adjacent to the mouth part all.

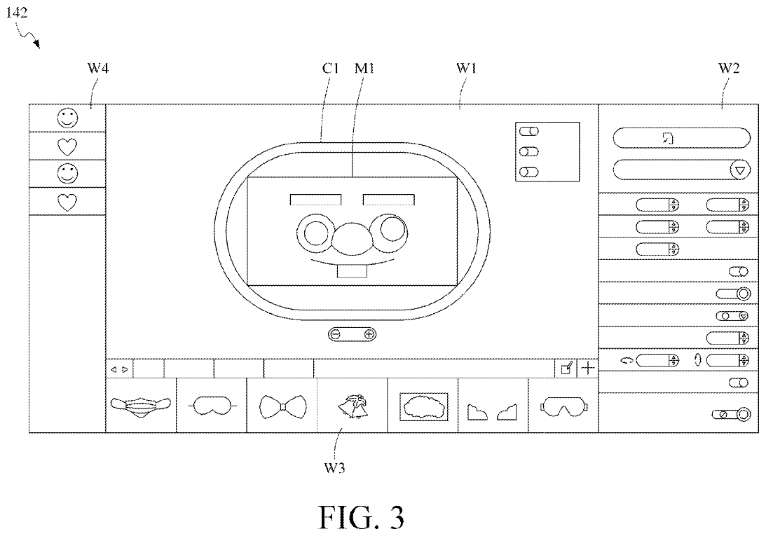

Referring to FIG. 3, FIG. 3 is a schematic diagram of an embodiment of a human-machine interface 142 of the face model building system 100 in FIG. 1.

As shown in the figure, the human-machine interface 142 includes a preview window W1, an adjustment window W2, an accessory window W3, and an emotion setting window W4. The adjustment window W2 presents all adjustable parameters corresponding to a specific facial feature animation object for the user to adjust. What is shown in the figure is the adjustment for a right eye part. In an embodiment, the user adjusts positions or sizes of the eyeball part, the white part, and an eyelid part of the right eye part in a touching manner through the human-machine interface 142. The accessory window W3 presents various accessories to be chosen and attached to the three-dimensional face model M1 by the user. The emotion setting window W4 allows the user to select an emotion type to be presented by the three-dimensional face model M1. The preview window W1 provides a preview function to present the three-dimensional face model M1 after parameter adjustment in real time. In an embodiment, as shown in the figure, the preview window W1 includes an analog display C1, and the three-dimensional face model M1 is presented on the analog display C1 to simulate a visual effect actually presented on the display platform 160.

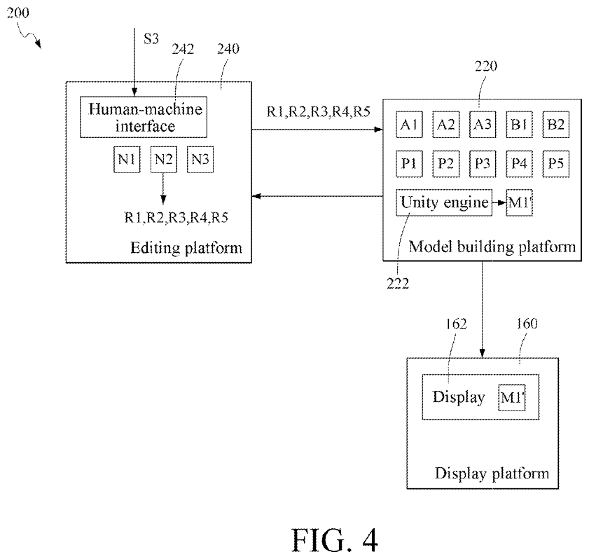

Referring to FIG. 4, FIG. 4 is a schematic block diagram of a face model building system 200 according to another embodiment of the disclosure.

Compared with the face model building system 100 shown in FIG. 1, in this embodiment, an editing platform 240 of the face model building system 200 is provided with a plurality of pieces of emotion data N1, N2, and N3. The editing platform 240 receives an emotion instruction S3 through a human-machine interface 242. The editing platform 240 selects one of the pieces of emotion data N1, N2, and N3 (Assume that the piece of emotion data N2 is selected) according to the emotion instruction S3, then adjusts the object parameters P1, P2, P3, P4, and P5 according to the selected piece of emotion data N2, and then returns the adjusted object parameters R1, R2, R3, R4, and R5 to a model building platform 220.

In an embodiment, the editing platform 240 presets the pieces of emotion data N1, N2, and N3 corresponding to various different emotions such as happiness, anger, and sadness. The user selects one of the pieces of emotion data N1, N2, and N3 (that is, inputting the emotion instruction S3 into the editing platform 240) through the human-machine interface 242.

Assuming that the selected piece of emotion data N2 corresponds to the happiness, the editing platform 240 adjusts the object parameters P1, P2, P3, P4, and P5 (such as, lifting positions of two ends of the mouth part all, or the like) according to the selected piece of emotion data N2, to generate the adjusted object parameters R1, R2, R3, R4, and R5; and then returns the adjusted object parameters R1, R2, R3, R4, and R5 to the model building platform 120.

In an embodiment, the piece of emotion data N2 includes the adjusted object parameters R1, R2, R3, R4, and R5. In an embodiment, the piece of emotion data N2 includes adjustment amounts of the adjusted object parameters P1, P2, P3, P4, and P5.

The model building platform 220 includes a Unity engine 222, and integrates the facial feature animation objects A1, A2, A3, B1, and B2 according to the adjusted object parameters R1, R2, R3, R4, and R5, to generate a three-dimensional face model M1′ which presents a specific emotion type.

The foregoing embodiments present a specific emotion type by adjusting the object parameters P1, P2, P3, P4, and P5. In other embodiments, an extra animation object is added besides the original facial feature animation objects A1, A2, A3, B1, and B2 according to the emotion instruction S3. In an embodiment, when the selected piece of emotion data N2 is crying, a teardrop is attached to the face base al as the extra animation object; and when the selected piece of emotion data N2 is shyness, a red circular animation object is attached to a position on the face base corresponding to a check.

Second, in this embodiment, the three-dimensional face model M1′ generated corresponding to the pieces of emotion data N1, N2, and N3 is a static three-dimensional face model or a dynamic three-dimensional face model. Specifically, the pieces of emotion data N1, N2, and N3 further include script data, so as to present a dynamic change of the three-dimensional face model.

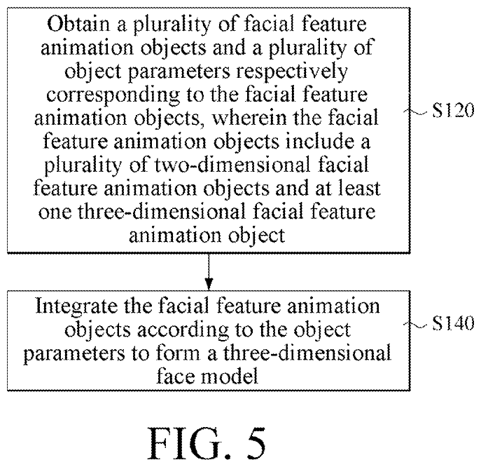

FIG. 5 is a flowchart of a face model building method according to an embodiment of the disclosure. The face model building method is performed by the face model building system 100 shown in FIG. 1.

First, as described in step S120, a plurality of facial feature animation objects A1, A2, A3, B1, and B2 and a plurality of object parameters P1, P2, P3, P4, and P5 respectively corresponding to the facial feature animation objects A1, A2, A3, B1, and B2 are obtained, where the facial feature animation objects A1, A2, A3, B1, and B2 include three two-dimensional facial feature animation objects A1, A2, and A3 and two three-dimensional facial feature animation objects B1 and B2. The step is performed by the model building platform 120 in FIG. 1.

Then, as described in step S140, the facial feature animation objects A, A2, A3, B1, and B2 are integrated according to the object parameters P1, P2, P3, P4, and P5 to generate a three-dimensional face model Ml. The step is performed by the model building platform 120 in FIG. 1.

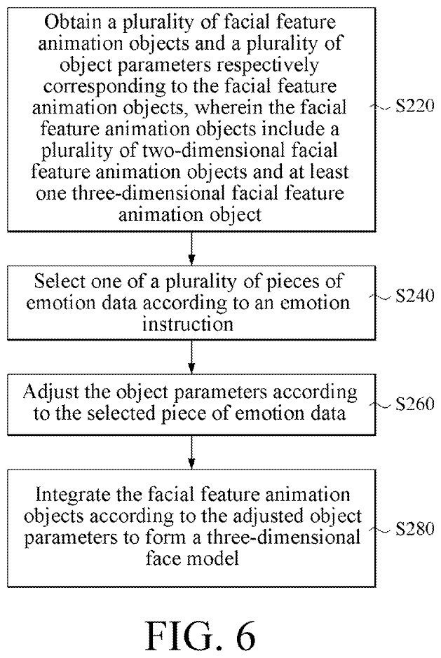

FIG. 6 is a flowchart of a face model building method according to another embodiment of the disclosure. The face model building method is performed by the face model building system 200 shown in FIG. 4.

First, as described in step S220, a plurality of facial feature animation objects A1, A2, A3, B1, and B2 and a plurality of object parameters P1, P2, P3, P4, and P5 respectively corresponding to the facial feature animation objects A1, A2, A3, B1, and B2 are obtained, where the facial feature animation objects A1, A2, A3, B1, and B2 include three two-dimensional facial feature animation objects A1, A2, and A3 and two three-dimensional facial feature animation objects B1 and B2. The step is performed by the model building platform 120 in FIG. 4.

Then, as described in step S240, one of a plurality of pieces of emotion data N1, N2, and N3 is selected according to an emotion instruction S3. The step is performed by the editing platform 240 in FIG. 4.

It is assumed that the piece of emotion data selected in step S240 is the piece of emotion data N2. Then, as described in step S260, the object parameters P1, P2, P3, P4, and P5 are adjusted according to the selected piece of emotion data N2 to generate object parameters R1, R2, R3, R4, and R5. The step is performed by the editing platform 240 in FIG. 4.

Then, as described in step S280, the facial feature animation objects A1, A2, A3, B1, and B2 are integrated according to the adjusted object parameters R1, R2, R3, R4, and R5 to generate a three-dimensional face model M1′. The step is performed by the model building platform 120 in FIG. 4.

Through the face model building system 100 and the method thereof provided by the disclosure, the model building platform 120 is configured to integrate the facial feature animation objects A1, A2, A3, B1, and B2 according to the object parameters P1, P2, P3, P4, and P5 to generate the three-dimensional face model M1 for use. When necessary, the three-dimensional face model M1 with a specific emotion effect is generated by integrating the use of the pieces of emotion data N1, N2, and N3, to meet the requirement of the user.

Further, the facial feature animation objects A1, A2, A3, B1, and B2 include a plurality of two-dimensional facial feature animation objects and at least one three-dimensional facial feature animation object. Using the two-dimensional facial feature animation objects to build a face model helps decrease the time and costs for model building, and using the three-dimensional facial feature animation object helps improve the delicacy and vividness of the face model.

The above is merely exemplary embodiments of the disclosure, and does not constitute any limitation on the disclosure. Any form of equivalent replacements or modifications to the technical means and technical content disclosed in the disclosure made by a person skilled in the art without departing from the scope of the technical means of the disclosure still fall within the content of the technical means of the disclosure and the protection scope of the disclosure.

What is claimed is:

1. A face model building method, applicable to a face model building system, the face model building method comprising:
obtaining a plurality of facial feature animation objects and a plurality of object parameters respectively corresponding to the facial feature animation objects, wherein the facial feature animation objects comprise a plurality of two-dimensional facial feature animation objects and at least one three-dimensional facial feature animation object; and
integrating the facial feature animation objects according to the object parameters to generate a three-dimensional face model.

2. The face model building method according to claim 1, wherein the three-dimensional facial feature animation object is an eye part.

3. The face model building method according to claim 2, wherein the eye part comprises a white part and an eyeball part, wherein a size of the white part is fixed.

4. The face model building method according to claim 1, wherein the two-dimensional facial feature animation objects comprise a face base, a nose part, and two eyebrow parts, wherein the face base comprises a mouth part.

5. The face model building method according to claim 4, wherein a periphery of the face base is fixed.

6. The face model building method according to claim 4, wherein the two-dimensional facial feature animation objects further comprise a tooth part, and the tooth part is adjacent to the mouth part.

7. The face model building method according to claim 1, wherein the object parameters comprise at least one of a position parameter, a size parameter, and a color parameter.

8. The face model building method according to claim 7, wherein the position parameter and the size parameter are both two-dimensional parameters.

9. The face model building method according to claim 1, wherein the face model building system is provided with a plurality of pieces of emotion data, and the step of obtaining a plurality of facial feature animation objects and a plurality of object parameters respectively corresponding to the facial feature animation objects comprises:
selecting one of the pieces of emotion data according to an emotion instruction; and
adjusting the object parameters according to the selected piece of emotion data.

10. A face model building system, comprising:
a model building platform, comprising a plurality of facial feature animation objects and a plurality of object parameters respectively corresponding to the facial feature animation objects, and integrating the facial feature animation objects according to the object parameters to generate a three-dimensional face model, wherein the facial feature animation objects comprise a plurality of two-dimensional facial feature animation objects and at least one three-dimensional facial feature animation object; and
a display platform, comprising a display, wherein the display platform receives the three-dimensional face model from the model building platform and presents the three-dimensional face model on the display.

11. The face model building system according to claim 10, further comprising an editing platform comprising a human-machine interface and a plurality of pieces of emotion data, wherein the editing platform receives an emotion instruction through the human-machine interface, selects one of the pieces of emotion data according to the emotion instruction, and adjusts the object parameters according to the selected piece of emotion data, wherein the model building platform integrates the facial feature animation objects according to the adjusted object parameters to generate the three-dimensional face model.
